(19) United States
(12) Patent Application Publication
(10) Pub. No.: US 2002/0059219 A1
(43) Pub. Date: May 16, 2002

(54) System and methods for web resource discovery

(76) Inventor: William T. Neveitt, Allston, MA (US)

Correspondence Address: PENNIE AND EDMONDS, 1155 AVENUE OF THE AMERICAS, NEW YORK, NY, 100362711

(21) Appl. No.: 09/906,927

(22) Filed: Jul. 17, 2001

Related U.S. Application Data
(60) Provisional application No. 60/219,146, filed on Jul. 17, 2000.

(51) Int. Cl. G06F 7/00

(52) U.S. Cl. 707/5

(57) ABSTRACT

The subject invention comprises a system for data mining, preferably comprising a sample generator component; a filtering system component; and a buffering component. The sample generator component is preferably configured to communicate with a plurality of search engines and to generate queries based on a sample repository of positive and negative sample documents, and comprises a feature extraction algorithm.

The subject invention also comprises a method for data mining, comprising the steps of (a) identifying candidate sample documents based on a category; (b) filtering candidate documents by applying a categorization model; (c) buffering the filtered documents; (d) labeling the buffered documents as positive or negative examples of the category; (e) retraining the categorization model, based on the labeled set of positive and negative example documents; (f) repeating steps ((b) through (e) until all candidate documents are processed; and (g) storing all labeled documents in a database.

### CROSS REFERENCE TO RELATED APPLICATIONS

This application claims the benefit of U.S. Provisional Application No. 60/219,146, filed Jul. 17, 2000.

### BACKGROUND

Identifying relevant documents in an on-line repository poses a difficult problem. The most widely-used method for access is the keyword query paradigm: a user submits words of interest and a system uses those words to retrieve matching text documents using various matching criteria. Although these systems may index a large number of documents, the relevance of the results for a specific task is often poor. There is thus a need for a system that leverages a large volume of documents already indexed by a set of existing keyword search engines and document indexers (collectively “engines” or “search engines”) to generate a collection of candidate documents, and then adaptively filters these resources.

Moreover, identifying predictive features for document classification is a difficult problem whose solution is critical to efficient overall performance of a document identification system. Trainable document classification systems generally perform classification by analyzing positive and negative example documents, often labeled as such by an end user of the system, into collections of simpler features. Existing feature selection algorithms for trainable classifiers are symmetric, in that they treat the positive and negative sample sets the same way. However, for many applications, the number of positive samples is much smaller than the number of negative samples available. In this case, standard feature selection methods are strongly biased towards terms that model the negative set, thereby requiring many thousands of features to model a class. Thus, there is a need for an asymmetric feature extraction method that seeks features that are explicitly predictive of the positive classes being modeled. Such a method results in a more accurate model using far fewer features.

### SUMMARY

The subject invention comprises a system for data mining, preferably comprising a sample generator component; a filtering system component; and a buffering component. The sample generator component is preferably configured to communicate with a plurality of search engines and to generate queries based on a sample repository of positive and negative sample documents, and comprises a feature extraction algorithm.

The subject invention also comprises a method for data mining, comprising the steps of (a) identifying candidate sample documents based on a category; (b) filtering candidate documents by applying a categorization model; (c) buffering the filtered documents; (d) labeling the buffered documents as positive or negative examples of the category; (e) retraining the categorization model, based on the labeled set of positive and negative example documents; (f) repeating steps ((b) through (e) until all candidate documents are processed; and (g) storing all labeled documents in a database.

### BRIEF DESCRIPTION OF THE DRAWINGS

FIG. 1A is a diagram of a preferred system embodiment of the present invention.

FIG. 1B is a flowchart depicting overall operation of a preferred system.

FIG. 2 comprises a flowchart of a feature extraction method of a preferred embodiment.

FIG. 3 is a flowchart of a sample generation method of a preferred embodiment.

FIG. 4 is a flowchart of a filtering component method of a preferred embodiment.

### DETAILED DESCRIPTION OF PREFERRED EMBODIMENTS

A preferred embodiment of the present invention comprises a system enabling a user to develop an adaptive, high-precision search engine to identify resources of interest. This system uses a set of existing keyword search engines and document indexers (collectively “engines” or “search engines”) to generate a collection of candidate documents, then adaptively filters these documents based on example documents provided by the user. Relevant documents are called positive samples, and other documents are called negative samples.

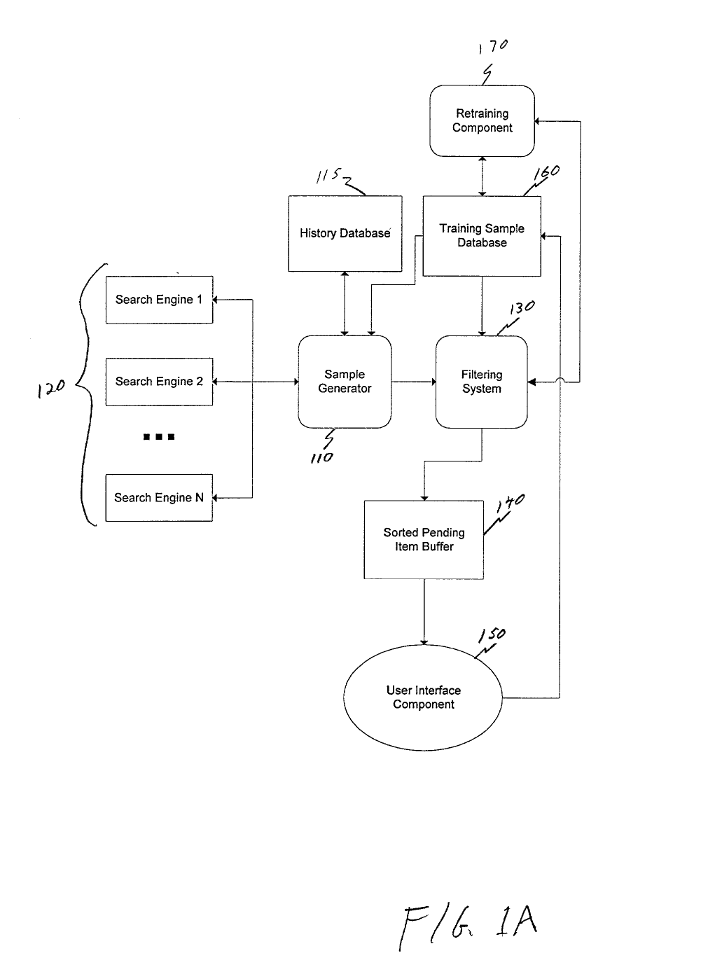

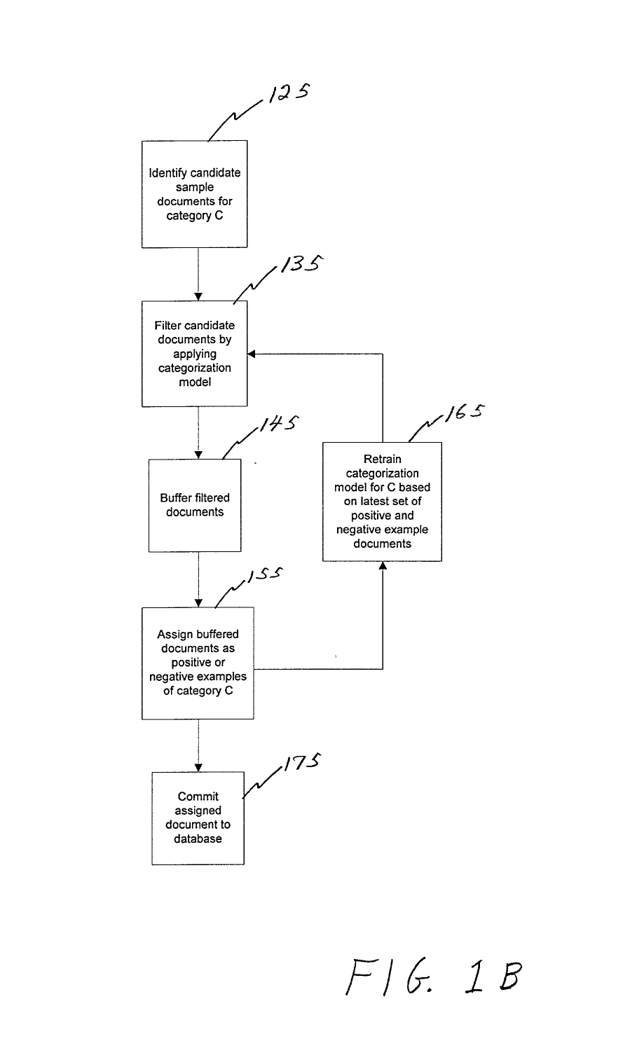

Overall System Architecture: A preferred embodiment of the overall system is shown in FIG. 1A. The system preferably comprises a sample generator component 110, a filter system component 130, and a buffer component 140. The system preferably communicates with a set of existing indexing sources (search engines). Each of these indexing sources accepts a keyword or key phrase search string as an input, and produces a list of matching documents sorted by decreasing relevance. The ability to communicate with multiple engines is especially useful (although not essential), since any one engine may only index a small fraction of the available documents in the domain.

FIG. 1B illustrates overall operation of the system shown in FIG. 1A. Given a category C, at step 125 the system identifies candidate sample documents. At step 135, the system filters candidate documents by applying a categorization model. At step 145, the system buffers the filtered documents. At step 155, the system labels the buffered documents as positive or negative examples of category C, then retrains the categorization model, based on this latest set of positive and negative example documents. Steps 135 through 165 are repeated until all candidate documents are processed, then at step 175 the labeled (“assigned”) documents are committed to a database.

A sample generator component 110 preferably incrementally generates a set of sample documents that contains positive samples indexed by search engines 120. Preferably, this set of candidate documents is compact, since each engine may index billions of web pages, for example, so simply downloading all the documents indexed by each engine is infeasible for most applications. In addition, sample generator 110 must deal with the fact that most search engines return no more than some maximum number of results, and that number is likely to be smaller than the total number of positive samples indexed by the engine. The sample generator 110 preferably submits a series of queries that are likely to cover the total set of positive samples available.

The sample generator 110 preferably incrementally constructs and makes use of a history database 115. This database 115 preferably contains a list of URLs that have been returned, and a list of queries that have been run. This information enables the sample generator 110 to avoid or at least minimize downloading the same document more than once or running the same query more than once for a given search engine 120. The sample generator 110 preferably also makes use of a repository 160 of positive and negative sample documents (described below) as a basis for determining the most appropriate query to issue next.

An illustrative example of how the sample generator 110 preferably determines the next query to issue is by using a “British Museum procedure” on the set of ordered features extracted from the positive and negative example documents. Specifically, let C be a category that is recognized by the system. Let A_{C} (the anchor set) be a set of baseline strings for the category C such that a positive example document is very likely to contain one or more of these strings. This set may be created by a user typing some inclusive keywords to bootstrap the procedure. Let F_{C} be the ordered set of features extracted from the set of example documents for category C using the feature extraction method outlined below. The set F_{C} is preferably ordered according to decreasing fitness. Let Q(n) be the set of queries with N keywords or key-phrases that are issued by the sample generator.

Then the set of queries Q(n) to be issued by sample generator 110 is the set of all distinct strings that contain one string from the set A_{C} and (n−1) distinct strings from the set F_{C}. Strings in the set Q(n) are ordered by the sum of the fitness of the terms selected from F_{C}. The sample generator 110 generates queries in Q(1), then Q(2), then Q(3), etc., up to some maximum value—or until the number of results returned from each indexing engine for a single query is less than some threshold count.

A primary purpose of filtering component 130 is to identify candidate documents that are most likely to be positive samples. Filtering component 130 categorizes each document based on applying a model derived from analyzing the features of positive and negative sample documents in the sample repository 160.

After filtering, candidate documents that are most likely to be positive samples are preferably sent to a buffer area 140, where they are preferably viewed by a human editor through a user interface. A human editor then preferably labels the document as either a positive or a negative sample and commits it to the sample repository.

We now describe each of the primary components in greater detail:

Sample Generator 110: The sample generator 110 preferably takes two inputs. The first is a list of required strings (a “product feature set”), also called herein the “anchor set” (set of anchor strings). Every document that is a positive sample will preferably contain one or more strings contained in the anchor set. The second input is a list of the top N word or phrase features (“best training features”) generated from the feature extraction algorithm described below. A feature may be a discrete entity such as a word, phrase, morphological pattern, syntactic relation, or textual formatting in a document. Given these two inputs, the sample generator 110 generates a set of distinct query strings by concatenating at least one feature from the N−1 or fewer features from the list of the best training features.

For each query string, the generator 110 issues the query to each available indexing source. For each result returned, if the result has not been classified already and is not already in the candidate set, the generator downloads the associated document and adds it to the candidate set. A record of the documents in the current candidate set is stored in the history database 115.

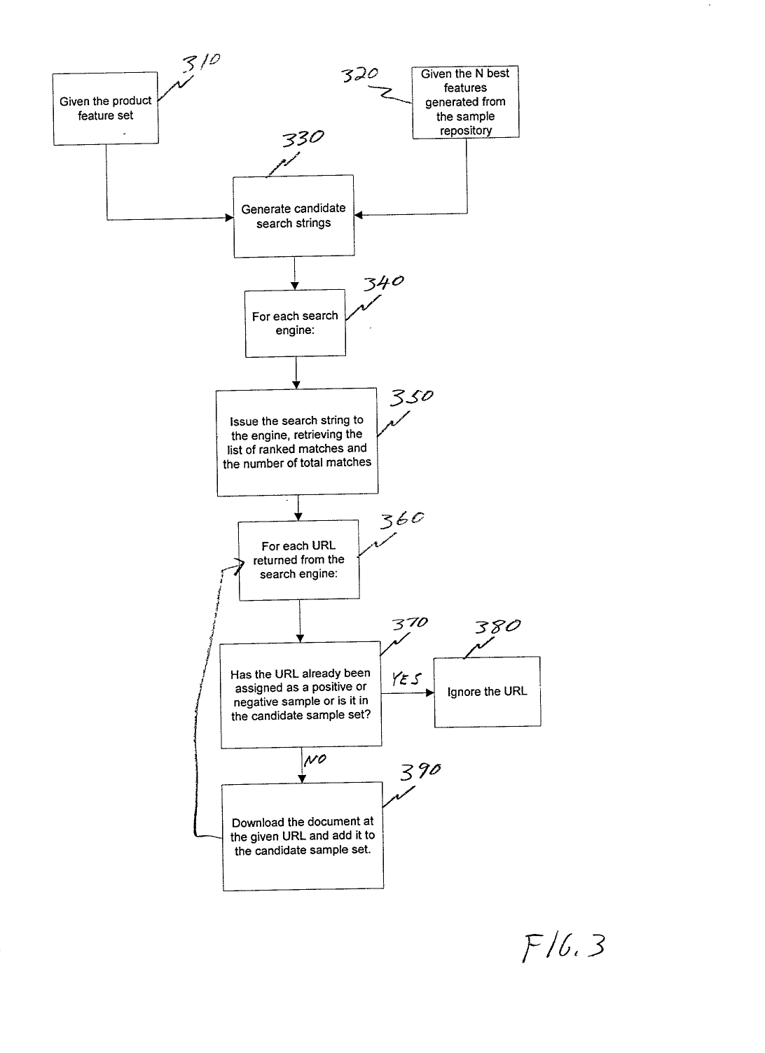

The sample generator 110 preferably incorporates logic that enables it to bound the number of documents in the candidate set so as to prevent too many documents from backing up in the system. As samples are passed through the system, additional candidates are downloaded as needed. Steps of sample generation are described in more detail in FIG. 3.

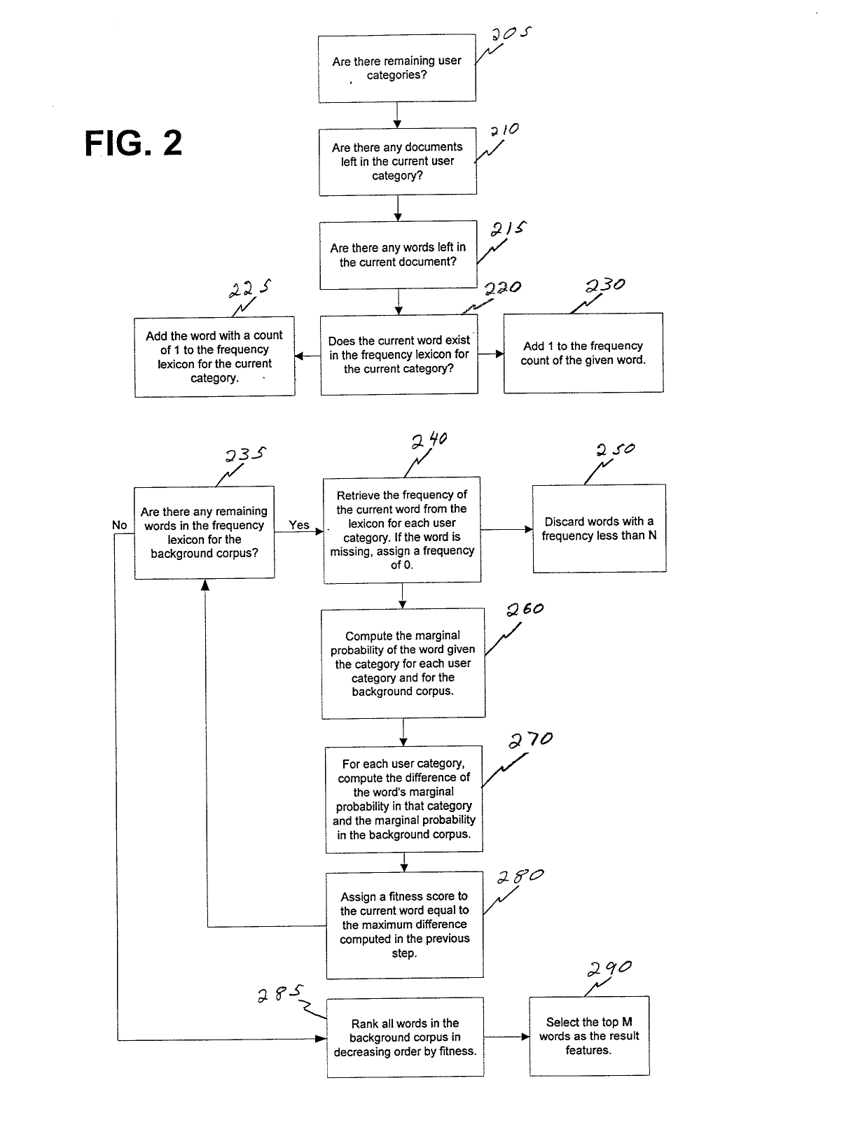

At step 310, the product feature set (anchor set) is received by the sample generator 110. At step 320, the N best features from the sample repository 160 generated by the feature extraction algorithm (see FIG. 2 and associated text) are received by sample generator 110. At step 330, sample generator 110 generates candidate search strings, as described in detail above.

Step 340 comprises repeating steps 350-360 for each search engine 120 until all search engines 120 have been dealt with. For each search engine 120, sample generator 110 at step 350 issues a candidate search string to the engine, and retrieves from that engine a list of ranked URL matches and a number of total matches.

Step 360 comprises repeating step 370-390 for each document URL received from a search engine 120 in step 350, until all document URLs for that engine have been considered. For each URL, at step 370 sample generator 110 checks (1) whether the document URL has already been designated a positive or negative sample, and (2) whether the current URL is already in the candidate set. If either (1) or (2) is true, then at step 380 the URL is ignored and the process returns to step 360. Otherwise, at step 390 the document is downloaded and added to the candidate sample set; then the process returns to step 360. If the URL has not yet been designated, then it is downloaded and added to the candidate sample set; then the process returns to step 360. After step 360 has been applied to each URL returned by a search engine 120, the process returns to step 340.

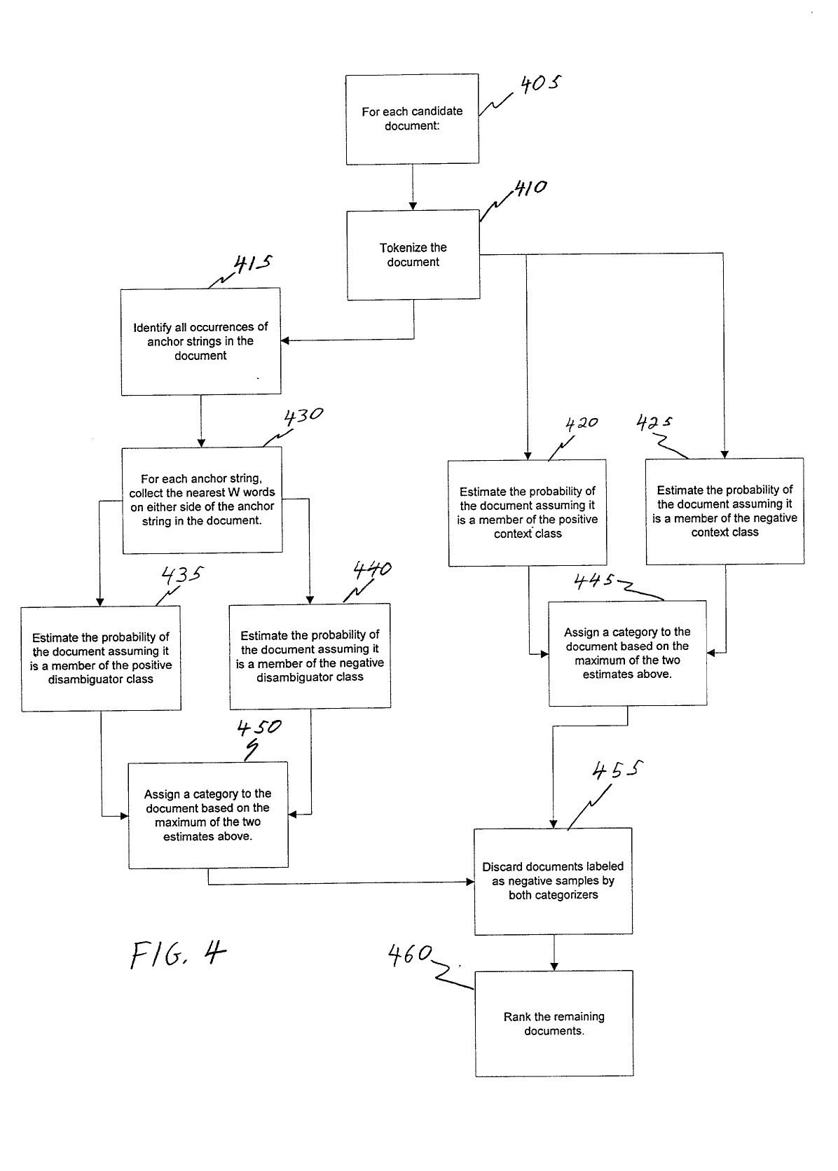

Filtering Component 130: The filtering component 130 preferably uses two categorizers to rank the documents in the candidate set. Each of these categorizers uses a probabilistic model that is estimated from the positive and negative samples in the sample repository; these models are re-estimated over time as needed. A preferred filtering component process is shown in detail in FIG. 4.

The first categorizer is preferably a disambiguating categorizer. The disambiguating categorizer identifies all occurrences of anchor strings in a given document. For each occurrence, the disambiguating categorizer collects the nearest W words on either side of the anchor string in the document. The probability of the document is then estimated as the product of the probability of each anchor string in the document (discussed below), times the product of the probabilities of the W window terms given the anchor string. These document probabilities are estimated for both the positive and negative sample sets, and the document is assigned to the set whose estimated probability is larger.

The second categorizer is preferably a contextual categorizer. The contextual categorizer treats all terms in each document uniformly, and assigns the document to a category based on the maximum estimated document probability as described above.

Referring to FIG. 4, at step 405 for each document in the candidate set, the document is tokenized at step 410. The two categorizers described above are preferably applied in parallel. Steps 415, 430, 435, 440, and 450 are performed by the disambiguating categorizer; steps 420, 425, and 445 are performed by the contextual categorizer.

We describe the disambiguating categorizer steps first. At step 415, all occurrences of anchor strings are identified in the document. At step 430, for each anchor string in the document, the categorizer collects the nearest W words in the document on either side of the anchor string. At step 435, the probability of the document is estimated, assuming it is a member of the positive disambiguator class. The probability of the document is estimated as the product of the probability of each anchor string in the document, times the product of the probabilities of the W window terms associated with the anchor string.

The probability of each anchor string (and indeed of each document) can be estimated in many ways, and many are equivalent in this context, as will be recognized by those skilled in the art. However, one nonlimiting illustrative example, presented to clarify the underlying event spaces, is as follows: estimate the probability of each anchor string S by probability

P(anchor string S|+sample)=(A+n)/(B+nC),

where n is a small positive constant<<A; A=# occurrences of anchor string S in positive sample documents; B=# of strings in positive sample documents; and C=# of distinct strings in positive sample documents. Estimate the probability of each string T of W window terms associated with the anchor string S by

P(string T|+sample ˆ anchor string S ˆ window)=(A+n)/(B+nC),

where n is a small positive constant <<A and A=occurrences of string T that occur within a distance of W/2 strings from the anchor string S in positive sample documents. We define the distance between two strings S1 and S2 in a document to be the absolute value of the difference in the positions of S1 and S2 in the document (where position is determined by numbering the strings with consecutive integers starting at the first string). We define B=# of strings occurring within a distance of W/2 strings from the anchor string S in a positive sample. We define C=# of distinct strings occurring within a distance of W/2 strings from the anchor string S in a positive sample.

The probability of the document is then estimated as the product of the probability of each of the anchor strings in the document times the product of the probabilities of the W window terms associated with the anchor string (thus, there is a term in the product for each anchor string that appears in the document).

In step 435 the probability of the document assuming it is a member of the positive disambiguator class (we limit ourselves to only the documents in the positive sample set for the category C when performing the probability estimation for that category (and vice versa for the negative class)) is estimated using the above (or equivalent) methods, and in step 440 the probability of the document assuming it is a member of the negative disambiguator class is estimated using methods analogous to those in step 435. At step 450, the document is assigned to a category (positive or negative sample set) depending on which estimate (the one from step 435 or the one from step 440, respectively) is larger.

Turning now to the steps performed by the contextual categorizer, at step 420 the probability of the document assuming it is a member of the positive context class is estimated. This estimation is preferably performed using positive document probability as the product of the prior probability that the document is positive (which can be estimated as: # positive docs/(# positive docs+# negative docs)) times the product of the conditional probability for every feature in the post-tokenized document given the positive class. An analogous procedure is used for the negative class. Note that in the disambiguating categorizer steps, we are computing this product using only the anchor strings and features near to them. In the contextual categorizer steps, we are computing the document probability using all features that are not removed during the tokenization process.

At step 425, the probability of the document assuming it is a member of the negative context class is estimated, using formulas analogous to those in step 420. At step 445, the document is assigned to a category (positive or negative sample set) depending on which estimate (the one from step 420 or the one from step 425, respectively) is larger.

Note that the particular method of probability estimation used is not as important as the choice of the underlying event spaces. The above “Laplacian smoothed” methods of estimation are intended as examples only. Any method that estimates the probability of the occurrence of an anchor string given the set of strings occurring in positive sample documents falls within a preferred embodiment of the present invention, although “maximum entropy smoothing” methods are especially preferred. Alternative, and clearly equivalent, methods are known to those skilled in the art; many can be found in standard texts in the field (see, for example, “Statistical Methods for Speech Recognition,” Chapters 13 & 15, by Frederick Jelinek (MIT Press, 1999)).

Documents that are categorized as negative samples by both categorizers (in steps 445 and 450) are preferably discarded, in step 455. At step 460 the remaining documents are ranked as follows: documents that are labeled as positive samples by both categorizers first, then documents that are labeled as positive by the disambiguating categorizer but negative by the contextual categorizer, then documents that are labeled positive by the contextual categorizer but negative by the disambiguating categorizer. Within each of these sets, documents are preferably ranked by the estimated probability assigned by the disambiguating categorizer.

The set of ranked documents is preferably written to an item buffer 140. Human editors preferably may read items in order from this pending buffer 140, display the given document and its predicted categorization, and label the document as a positive or negative sample. The labeled document is then added to the training sample repository 160.

Feature Extraction (see FIG. 2): Identifying predictive features for document classification is a critical problem whose solution is critical to efficient overall performance of a document identification system. Trainable document classification systems generally perform classification by analyzing positive and negative example documents, often labeled as such by an end user of the system, into collections of simpler features. Existing feature selection algorithms for trainable classifiers are symmetric, in that they treat the positive and negative sample sets the same way. However, for many applications, the number of positive samples is much smaller than the number of negative samples available. In this case, standard feature selection methods are strongly biased towards terms that model the negative set, thereby requiring many thousands of features to model a class.

FIG. 2 has two parts. The top part (steps 205-230) describes an algorithm for building a feature lexicon from a set of samples. This algorithm is somewhat standard and is included mostly as context for the bottom part. At step 205 the algorithm checks whether there are remaining user categories. If not, the algorithm halts. If so, the algorithm proceeds to step 210, where it checks whether there are any documents left in the current user category. If not, the algorithm halts. If so, the algorithm proceeds to step 215, where it checks whether there are any words left in the current document. If not, the algorithm terminates. If so, the algorithm proceeds to step 220, where it checks whether the current word exists in the frequency lexicon for the current category. If not, at step 225 the algorithm adds the word, with a count of 1, to the frequency lexicon for the current category. If the current word does exist in the frequency lexicon for the current category, at step 230 the algorithm adds 1 to the frequency count of the current word.

The bottom part (steps 235-290) of FIG. 2 is a flowchart for a preferred feature extraction (FE) algorithm. This algorithm is used by the sample generator 110 to determine the set of terms F_{C} (defined above) from which to build new queries, and it is also used by both the disambiguating and contextual categorizers to establish the dictionary of valid features to be considered in the document tokenization.

Here, we describe asymmetric feature extraction that seeks features that are explicitly predictive of the positive classes being modeled. A feature may be a discrete entity such as a word, phrase, morphological pattern, syntactic relation, or textual formatting in a document. A preferred feature extraction algorithm ranks candidate features according to the maximum margin between a marginal positive class probability and the probability of that feature in the negative or background distribution. The steps of the algorithm are displayed in detail in FIG. 2.

At step 235 the FE algorithm checks whether there are any remaining words in the frequency lexicon for the background corpus. If not, the algorithm proceeds to step 285. If so, the algorithm proceeds to the next word and to step 240, where it retrieves the frequency of the current word from the lexicon for each user category. If the word is missing, it is assigned a frequency of zero (0). At step 250, words with a frequency of less than a preset number N are discarded.

At step 260 the FE algorithm computes a marginal probability of the current word, given the category, for each user category and for the background corpus. That is, the FE algorithm computes, for each user category and for the background category, the probability of the current feature, assuming the current document is an example of the current category. At step 270, for each user category, the FE algorithm computes the difference between the current word's marginal probability in that category and the word's marginal probability in the background corpus.

At step 280 the FE algorithm assigns a fitness score to the current word. The fitness score is preferably the maximum difference over the user categories of the differences computed in step 270. After step 280 the FE algorithm goes to step 235. If there are no remaining words in the frequency lexicon for the background corpus, the FE algorithm goes to step 285.

At step 285, the FE algorithm ranks all words in the background corpus in decreasing order by fitness score. At step 290 the FE algorithm selects the top M words as the result features, where M is a preset integer.

Although the subject invention has been described with reference to preferred embodiments, numerous modifications and variations can be made that will still be within the scope of the invention. No limitation with respect to the specific embodiments disclosed herein other than indicated by the appended claims is intended or should be inferred.

What is claimed is:

1. A system for data mining, comprising:
a sample generator component;
a filtering system component; and
a buffering component.

2. A system as in claim 1, wherein said sample generator component comprises a feature extraction component.

3. A system as in claim 1, wherein said sample generator component is configured to communicate with a plurality of search engines.

4. A system as in claim 1, wherein said sample generator component is configured to generate a plurality of queries based on a sample repository of positive and negative sample documents.

5. Software for data mining, said software comprising:
a sample generator component;
a filtering system component; and
a buffering component.

6. Software as in claim 5, wherein said sample generator component comprises a feature extraction algorithm.

7. Software as in claim 5, wherein said sample generator component is configured to communicate with a plurality of search engines.

8. Software as in claim 5, wherein said sample generator component is configured to generate a plurality of queries based on a sample repository of positive and negative sample documents.

9. A method for data mining, comprising the steps of:
(a) identifying candidate sample documents based on a category;
(b) filtering candidate documents by applying a categorization model;
(c) buffering said filtered documents;
(d) labeling said buffered documents as positive or negative examples of said category;
(e) retraining said categorization model, based on said labeled set of positive and negative example documents;
(f) repeating steps ((b) through (e) until all candidate documents are processed; and
(g) storing all labeled documents in a database.

10. A method for feature extraction, comprising the steps of:
(a) receiving a frequency of a current word from a lexicon for each user category of a plurality of user categories;
(b) discarding words with a frequency below a given integer;
(c) computing a marginal probability of said current word, given the category, for each user category and for a background corpus;
(d) for each user category, computing a difference between said current word's marginal probability in that category and said word's marginal probability in said background corpus; and
(e) assigning a fitness score to said current word, wherein said fitness score is the maximum of the differences computed in step (d).

11. A method for sample generation, comprising the steps of:
receiving a product feature set;
receiving a plurality of features generated by feature extraction software;
generating candidate search strings; and
communicating with a plurality of search engines.

12. A method according to claim 11, wherein said step of communicating with a plurality of search engines comprises, for each search string, and for each search engine:
sending the search string to the search engine;
receiving a ranked list of URLs of matches from the search engine; and
receiving a number of total matches from the search engine.

13. A method according to claim 12, further comprising the step of, for each URL in said list:
checking whether the URL is in a candidate sample set;
checking whether the URL has been designated a positive or negative sample; and
if appropriate, downloading a document corresponding to the URL and adding it to a candidate sample set.

14. A method for categorizing documents comprising the steps of, for each document:
tokenizing the document;
applying a disambiguating categorizer to the document;
assigning the document to a first category;
applying a contextual categorizer to the document;
assigning the document to a second category (which could be the same as said first category); and
categorizing the document based on the nature of said first and second categories.

15. A method according to claim 14, wherein said step of applying a disambiguating categorizer comprises:
identifying all occurrences of anchor strings in said document;
for each anchor string, collecting the nearest W words on either side of said anchor string in said document;
estimating a first probability of said document assuming it is a member of a first disambiguator class; and
estimating a second probability of said document assuming it is a member of a second disambiguator class.

16. A method as in claim 15, wherein said step of assigning the document to a first category is based on the maximum of the two estimates found in said step of applying a disambiguating categorizer.

17. A method as in claim 14, wherein said first and second categories are either positive samples or negative samples.

18. A method as in claim 17, further comprising the step of discarding documents categorized as negative samples by the disambiguating categorizer and by the contextual categorizer.

19. A method as in claim 18, further comprising ranking remaining documents according to said first probability.

20. A method as in claim 14, wherein said step of applying a contextual categorizer to the document comprises the steps of:
estimating a first probability of said document assuming it is a member of a positive context class; and
estimating a second probability of said document assuming it is a member of a negative context class.

21. A method as in claim 20, wherein said step of assigning the document to a second category is based on the maximum of the two estimates found in said step of applying a contextual categorizer.
